(19) United States
(12) Patent Application Publication
(10) Pub. No.: US 2017/0116047 A1
(43) Pub. Date: Apr. 27, 2017

(54) Further applications of Reading State control - A method for repositioning reading material on electronic devices

(71) Applicant: Khozem Z. Dohadwala, Naperville, IL (US)

(72) Inventor: Khozem Z. Dohadwala, Naperville, IL (US)

(21) Appl. No.: 15/256,701

(22) Filed: Sep. 5, 2016

Related U.S. Application Data
(63) Continuation-in-part of application No. 14/922,168, filed on Oct. 25, 2015.

(51) Int. Cl. G06F 9/54

(52) U.S. Cl. CPC G06F 9/541; G06F 9/547

(57) ABSTRACT

Specification details how Reading State control will be integrated into a Reader App, lists additional methods to identify articles, demonstrates metrics that can be collected by the Reading State control, shows methods to associate metadata to article identifiers and demonstrates how useful analytics can be performed using these metrics with and without metadata on article identifiers.

### RELATED APPLICATIONS

The current application is a CIP (continuation-in-part) of another co-pending U.S. application Ser. No. 14/922,168, filed Oct. 25, 2015, titled “Reading State—A method for repositioning reading material on electronic devices”. The current application incorporates by reference the application mentioned above in its entirety.

### BACKGROUND

The related application (Ser. No. 14/922,168) proposed a design that solves the issue of remembering how far someone had read an article and positioning the article very closely to the point up to which the article was read before, hence providing continuity and a quick way to continue reading incompletely read articles. This application extends the use of Reading State control by specifying its mode of usage, lists additional methods for indexing articles, specifies metrics that can be collected by the control, shows methods to associate metadata to article identifiers and demonstrates how analytics can be performed on metrics with and without metadata.

### BRIEF SUMMARY OF THE INVENTION

A software control is integrated into applications that provide functionality to read articles. This control tracks and collects various metrics associated with the reading behavior of the reader. The control also provides means to associate metadata for an article.

The control transmits the data consisting of article identifiers, optional metadata and other metrics to a common data storage site on Internet. This data, collected on a common data storage site, can be used for performing various analytics to provide useful insight to content providers and consumers of content analytics on the reading behavior of the readers.

### BRIEF DESCRIPTION OF THE DRAWINGS

FIG. 1—Transmitting metrics collected by Reading State control to a common data storage site on Internet.

FIG. 2—Associating metadata for article identifiers in the reading app that has Reading State control integrated.

FIG. 3—Associating metadata for article identifiers on the data collected at common data storage site.

### DETAILED DESCRIPTION AND BEST MODE OF IMPLEMENTATION

Reading State control is not software that can be installed and used on its own. It is a software control that has to be integrated into an existing software application used for reading articles (Reader App). The Reading State control will be developed as a software module that will expose a programming interface (API). The code of the Reader App will invoke the various methods and functions from the Reading State control API to provide the various features and capabilities of the Reading State control.

Related application (Ser. No. 14/922,168) described using a hash of first N characters of an article as one method to derive an article identifier. Most of the articles read on electronic devices through a reading application (app) will also be referenced by a URL (Uniform Resource Locator), which is a standard way of addressing content on web. The URL can also be used as a unique identifier for an article. Since the Reading State control will have to be integrated into the actual code of a reading app, a custom article identifier as defined by the content provider can also be used as the article identifier.

The Reading State control tracks the reading level of a particular article within a reading app on a particular electronic device. The level of reading of an article by a reader is one metric. There are a certain other useful metrics associated with the reading behavior of the reader. These metrics will also be captured by the Reading State control. These metrics are basic metrics and using these basic metrics more useful metrics can be derived. The basic metrics are:
1. The date time when a reader starts reading an article.
2. The possible use of the control to reposition the article.
3. The date time of every scroll performed by a reader on an article.
4. The date time when the reader stops reading an article.

Other metrics can be derived using the basic metrics above, these derived metrics are:
1. Total amount of reading time for an article by a reader.
2. Total time duration, which is the time period between the start time of first reading of the article and the end time of the last reading on an article by a reader.

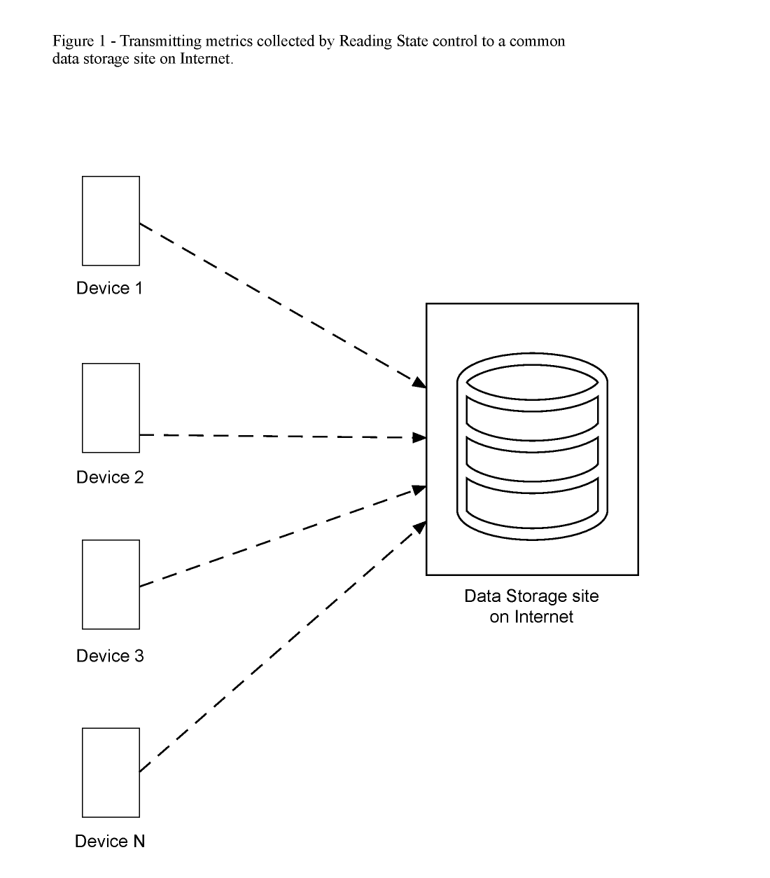

The control will persist the basic metrics on the electronic device. These metrics can be transmitted from the electronic device to a common data storage location like a cloud storage service on Internet. The API to transmit these metrics will be provided as part of the API for the control and use of this API feature will be integrated into the code of the Reader App in a way that does not affect the reading experience of the app. FIG. 1 shows transmission of Reading State metrics from electronic devices to a common data storage on Internet. The Reading State metrics collected at a common data storage location can be used for very useful analytics of reader interest and behavior.

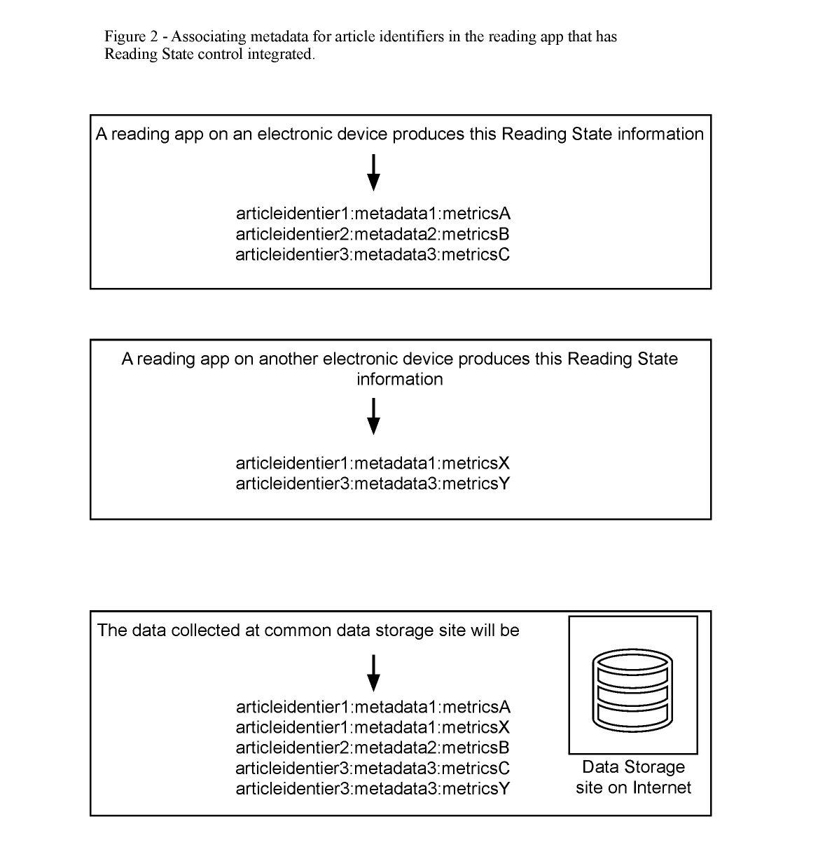

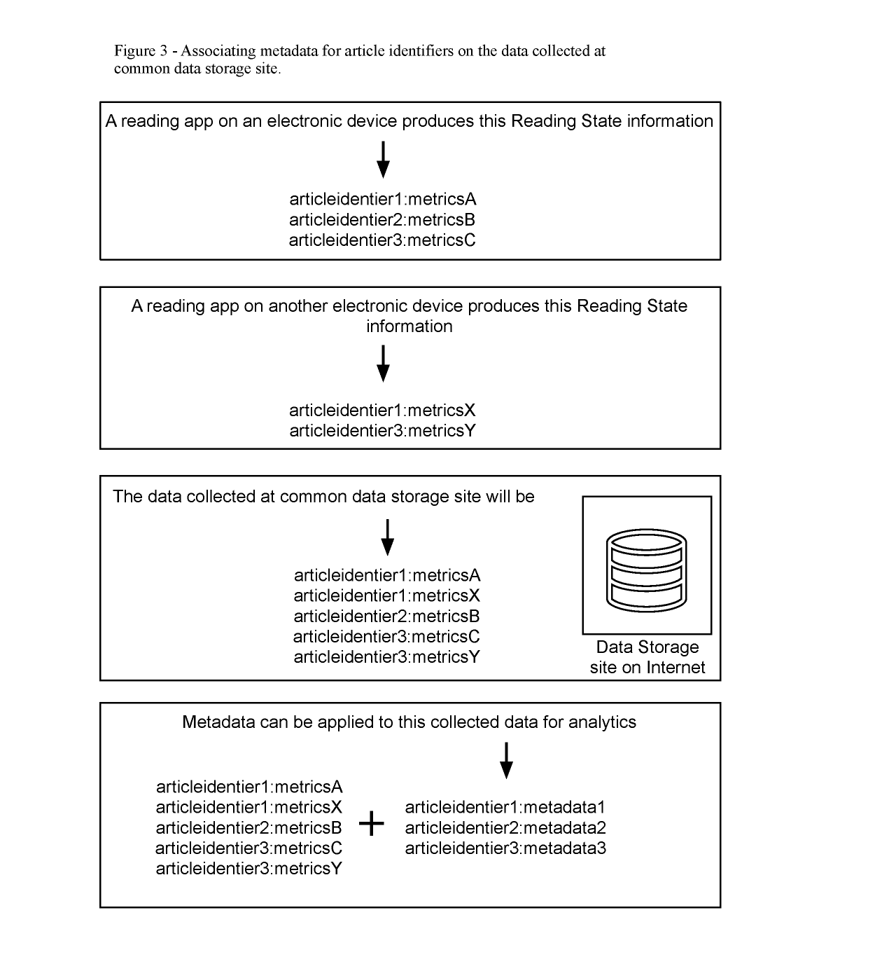

Reading State control associates an article identifier that uniquely identifies a particular article. Metadata about the article can also be associated to the article identifier. The association of metadata with the article identifier can be done as part of integration of the Reading State control within a Reader app or the metadata associated with the article identifier can be provided at the time of analytics. This metadata will be specific to the content provider and can also be based on the analytics that need to be performed. FIG. 2 shows how metadata associated with article identifiers and the metrics will be collected by the Reading State control and transmitted to a common data storage site. FIG. 3 shows how metadata associated with article identifiers can be provided on the collected data, which only contain article identifier and metrics information.

Some examples of metadata elements are author name(s) and topic(s). Given the metadata for a specific article identifier, analytics can produce useful information on the level of interest by the readers across all articles related by some common metadata element(s). An example of analytics, based on the sample metadata elements described above, can provide answers to questions like:
1. How many readers read a significant portion of an article by an author?
2. How soon after publishing of an article did some portion of readers start reading that article?
3. How long on average did the reader take to read an article?
4. How many readers read a significant portion of an article multiple times?
5. What are the topics that readers are interested in today?
6. What authors and topics were very widely read during a given time period?

Analytics on the Reading State metrics data can also be performed in absence of metadata. However, these analytics will be limited on just specific article identifiers, as the metadata elements that connect various article identifiers together will be missing.

What is claimed is:

1. Development of Reading State control as a software module that provides a programming interface (API) to be used by Reader apps to integrate the Reading State control.

2. Collection of basic metrics associated with the reading behavior of the reader.

3. Association of metadata to an article identifier using an API feature of Reading State control.

4. Transmission of article identifiers, optional metadata and the basic metrics to a common data storage site on Internet.

5. Performing analytics on the article metadata and basic metrics.
